(19) United States
(12) Patent Application Publication
(10) Pub. No.: US 2026/0120948 A1
(43) Pub. Date: Apr. 30, 2026

(54) MULTILAYER CERAMIC CAPACITOR AND METHOD OF MANUFACTURING THE SAME

(71) Applicant: SAMSUNG ELECTRO-MECHANICS CO., LTD., Suwon-si (KR)

(72) Inventors: Yura Shin, Suwon-si (KR); Choongseop Jeon, Suwon-si (KR); Seung Yong Lee, Suwon-si (KR); Dong Chan Seo, Suwon-si (KR); Kwanghee Nam, Suwon-si (KR)

(73) Assignee: SAMSUNG ELECTRO-MECHANICS CO., LTD., Suwon-si (KR)

(21) Appl. No.: 19/210,631

(22) Filed: May 16, 2025

(30) Foreign Application Priority Data
Oct. 28, 2024 (KR) 10-2024-0148901
Dec. 26, 2024 (KR) 10-2024-0197251

(51) Int. Cl. H01G 4/12; H01G 4/30

(52) U.S. Cl. CPC H01G 4/12; H01G 4/30

(57) ABSTRACT

A multilayer ceramic capacitor and a method of manufacturing the multilayer ceramic capacitor including a capacitor body including a dielectric layer and an internal electrode layer, and an external electrode disposed on an outer surface of the capacitor body, wherein the dielectric layer comprises a first element including at least one selected from cerium (Ce), gadolinium (Gd), samarium (Sm), and lanthanum (La); and a second element including at least one selected from erbium (Er), yttrium (Y), thulium (Tm), and ytterbium (Yb), and a molar ratio of the first element to the second element is 1.5 to 4.0.

### CROSS-REFERENCE TO RELATED APPLICATION

This application claims priority to and the benefit of Korean Patent Application No. 10-2024-0197251 filed in the Korean Intellectual Property Office on Dec. 26, 2024, and Korean Patent Application No. 10-2024-0148901 filed in the Korean Intellectual Property Office on Oct. 28, 2024, the entire contents of which are incorporated herein by reference.

### BACKGROUND

### (a) Technical Field

The present disclosure relates to a multilayer ceramic capacitor and a manufacturing method thereof.

### (b) Description of the Related Art

As electronic components using a ceramic material, there are a capacitor, an inductor, a piezoelectric element, a varistor, a thermistor, and the like. Among ceramic electronic components, a multilayer ceramic capacitor (MLCC) may be used in various electronic devices due to advantages such as a small size, a high capacitance, an easy mounting feature, and the like.

For example, a multilayer ceramic capacitor (MLCC) may be used in a chip type condenser mounted on a board of several electronic products such as image devices, for example, liquid crystal displays (LCD), plasma display panels (PDP), or the like, computers, personal portable terminals, smartphones, and the like, to serve to charge or discharge electricity therein or therefrom.

Recently, with the miniaturization of multilayer ceramic capacitors, research is being conducted on controlling the type and amount of additives added to a powder of dielectric matrix to achieve excellent performance such as reliability.

### SUMMARY

An embodiment provides a multilayer ceramic capacitor having excellent reliability.

Another embodiment provides a method of manufacturing a multilayer ceramic capacitor.

An embodiment provides a multilayer capacitor including a capacitor body including a dielectric layer and an internal electrode layer, and an external electrode disposed on an outer surface of the capacitor body, wherein the dielectric layer includes a first element including at least one selected from cerium (Ce), gadolinium (Gd), samarium (Sm), and lanthanum (La); and a second element including at least one selected from erbium (Er), yttrium (Y), thulium (Tm), and ytterbium (Yb), and a molar ratio of the first element to the second element is 1.5 to 4.0.

The first element may include cerium (Ce), and the second element may include erbium (Er).

A molar ratio of cerium (Ce) to erbium (Er) may be 1.5 to 4.0.

The first element may include samarium (Sm), and the second element may include yttrium (Y).

A molar ratio of samarium (Sm) to yttrium (Y) may be 1.5 to 4.0.

The dielectric layer may further include titanium (Ti), and the dielectric layer may include the first element in an amount of 0.6 part by mole to 8 parts by mole based on 100 parts by mole of titanium (Ti).

The dielectric layer may further include titanium (Ti), and the dielectric layer may include the second element in an amount of 0.15 part by mole to 5 parts by mole based on 100 parts by mole of titanium (Ti).

The dielectric layer may include a Si-based secondary phase.

The Si-based secondary phase may include silicon (Si); and at least one selected from cerium (Ce), gadolinium (Gd), samarium (Sm), lanthanum (La), erbium (Er), yttrium (Y), thulium (Tm), ytterbium (Yb), aluminum (Al), magnesium (Mg), and manganese (Mn).

The Si-based secondary phase may include silicon (Si) in an amount of 20 mol % to 80 mol % based on a total amount of the Si-based secondary phase.

The Si-based secondary phase may include at least one selected from CeₓEr_{y}Si₂O₇ (0≤x≤2, 0≤y≤2), CeₓEr_{y}SiO₅ (0≤x≤2, 0≤y≤2), a Si—O—Al bond-containing compound, a Si—O—Mg bond-containing compound, and a Si—O—Mn bond-containing compound.

The dielectric layer may include a plurality of dielectric layers, the internal electrode layer may include a plurality of internal electrode layers, the capacitor body may include an active region, the active region may include the plurality of dielectric layers and the plurality of internal electrode layers, where each internal electrode layer among the plurality of internal electrode layers and each dielectric layer among the plurality of dielectric layers are alternately disposed, and an area occupied by the Si-based secondary phase may be greater than 0 and less than or equal to 2.0 μm² based on an area of 10 μm×10 μm of the active region.

The dielectric layer may be free of dysprosium (Dy), terbium (Tb), or both.

The dielectric layer may include a plurality of dielectric layers, the internal electrode layer may include a plurality of internal electrode layers, the capacitor body may include an active region, the active region may include the plurality of dielectric layers and the plurality of internal electrode layers, where each internal electrode layer among the plurality of internal electrode layers and each dielectric layer among the plurality of dielectric layers are alternately disposed, and an area occupied by the Si-based secondary phase may be greater than 0 and less than or equal to 2.0 μm² based on an area of 10 μm×10 μm of the active region.

Another embodiment provides a multilayer capacitor including a capacitor body including a dielectric layer including a plurality of dielectric layers, and an internal electrode layer including a plurality of internal electrode layers, and an external electrode disposed on an outer surface of the capacitor body, wherein the capacitor body comprises an active region, the active region may include the plurality of dielectric layers and the plurality of internal electrode layers, where each internal electrode layer among the plurality of internal electrode layers and each dielectric layer among the plurality of dielectric layers are alternately disposed, the dielectric layer comprises a first element including at least one selected from cerium (Ce), gadolinium (Gd), samarium (Sm), and lanthanum (La); a second element including at least one selected from erbium (Er), yttrium (Y), thulium (Tm), and ytterbium (Yb), and a Si-based secondary phase, and an area occupied by the Si-based secondary phase is greater than 0 and less than or equal to 2.0 μm² based on an area of 10 μm×10 μm of the active region.

Another embodiment provides a method of manufacturing a multilayer ceramic capacitor which includes: preparing a dielectric slurry from a mixture including a barium titanate-based compound, a first element-containing compound, and a second element-containing compound; manufacturing a plurality of dielectric green sheets from the dielectric slurry and forming a conductive paste layer on a surface of two or more dielectric green sheets among the plurality of dielectric green sheets; manufacturing a dielectric green sheet stack by stacking the two or more dielectric green sheets on which the conductive paste layer is formed; manufacturing a capacitor body including a dielectric layer and an internal electrode layer by firing the dielectric green sheet stack; and forming an external electrode on a surface of the capacitor body, wherein the first element-containing compound is a compound containing a first element including at least one selected from cerium (Ce), gadolinium (Gd), samarium (Sm), and lanthanum (La), the second element-containing compound is a compound containing a second element including at least one selected from erbium (Er), yttrium (Y), thulium (Tm), and ytterbium (Yb), and the first element-containing compound and the second element-containing compound are mixed so that a molar ratio of the first element and the second element is 1.5:1 to 4:1.

The first element-containing compound and the second element-containing compound may each independently be an oxide, a nitride, a salt compound, or a compound in a form of a sol dispersed in an organic solvent.

The first element-containing compound may include cerium nitride, and the second element-containing compound may include erbium nitride.

The mixture may further include at least one selected from a silicon (Si)-containing compound, an aluminum (Al)-containing compound, a magnesium (Mg)-containing compound, and a manganese (Mn)-containing compound.

The silicon (Si)-containing compound, the aluminum (Al)-containing compound, the magnesium (Mg)-containing compound and the manganese (Mn)-containing compound may each independently, when present, be an oxide, a nitride, a salt compound, or a compound in the form of a sol dispersed in an organic solvent.

The mixture may further include the silicon (Si)-containing compound in an amount of 0 parts by mole to about 4 parts by mole or less based on 100 parts by mole of the barium titanate-based compound.

The silicon (Si)-containing compound may include silicon oxide.

The dielectric green sheet stack may be fired under a hydrogen concentration of 1.0% H₂ or lower.

The multilayer ceramic capacitor according to an embodiment can have excellent reliability.

### BRIEF DESCRIPTION OF THE DRAWINGS

FIG. 1 is a perspective view showing a multilayer ceramic capacitor according to an embodiment.

FIG. 2 is a cross-sectional view of the multilayer ceramic capacitor taken along line I-I′ of FIG. 1.

FIG. 3 is a cross-sectional view of the multilayer ceramic capacitor taken along line II-II′ of FIG. 1.

FIG. 4 is an exploded perspective view illustrating the stacked structure by disassembling the capacitor body of the embodiment illustrated in FIG. 1.

FIGS. 5A and 5B are electron probe microanalysis (EPMA) images of the active region according to Example 1.

FIGS. 6A to 6E are each a laser ablation-induced coupled plasma (LA-ICP) analysis image of the dielectric layer according to Example 3.

FIGS. 7A to 7E are each a laser ablation-induced coupled plasma (LA-ICP) analysis image of the dielectric layer according to Comparative Example 1.

FIG. 8 is a transmission electron microscopy-energy dispersive spectroscopy (TEM-EDS) analysis image of the active region according to Example 2.

FIG. 9 is a transmission electron microscopy-energy dispersive spectroscopy (TEM-EDS) analysis image of the active region according to Example 4.

FIG. 10 is a transmission electron microscopy-energy dispersive spectroscopy (TEM-EDS) analysis image of the active region according to Comparative Example 1.

FIGS. 11A to 11C are each an image showing the measurement of the area of the Si-based secondary phase in the active region according to Comparative Example 1 and Examples 2 and 4, respectively.

FIG. 12 is a graph evaluating highly accelerated life test (HALT) of the multilayer ceramic capacitor according to Example 2.

FIG. 13 is a graph evaluating highly accelerated life test (HALT) of the multilayer ceramic capacitor according to Example 4.

FIG. 14 is a graph evaluating highly accelerated life test (HALT) of the multilayer ceramic capacitor according to Comparative Example 1.

### DETAILED DESCRIPTION

Hereinafter, the present disclosure will be described in detail hereinafter with reference to the accompanying drawings, in which embodiments of the present disclosure are shown. The drawings and description are to be regarded as illustrative in nature and not restrictive. Like reference numerals designate like elements throughout the specification. In the accompanying drawings, some components are exaggerated, omitted, or schematically illustrated, and the size of each component does not entirely reflect the actual size.

The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various components, the components are not limited to such terms. These terms are only used to distinguish one component from another component.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” in a direction opposite to gravity.

Throughout the specification, the terms “comprise” or “have” are intended to specify the presence of stated features, integers, steps, operations, components, components or a combination thereof, but do not preclude the presence or addition of one or more other features, integers, steps, operations, components, components, and/or groups thereof. Therefore, unless explicitly described to the contrary, the word “comprise” and variations such as “comprises” or “comprising” will be understood to imply the inclusion of stated elements but not the exclusion of any other elements.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Throughout the specification, the term “connected” does not mean only that two or more constituent components are directly connected, but may also mean that two or more constituent components are indirectly connected through another constituent component, that two or more components are electrically connected as well as physically connected, or that two or more constituent components are referred to by different names but are united by location or function.

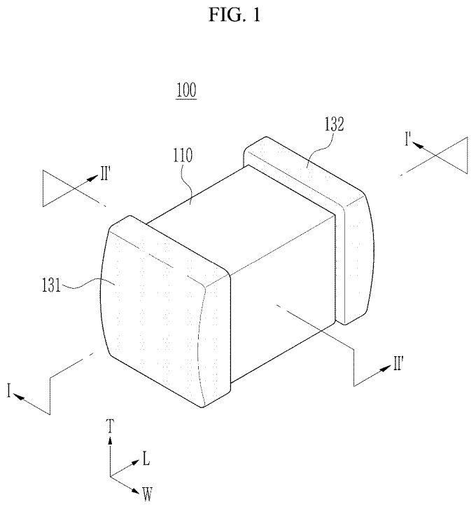

Hereinafter, a multilayer ceramic capacitor according to an embodiment will be described with reference to FIGS. 1 to 4.

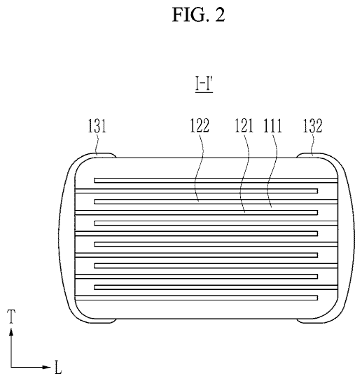

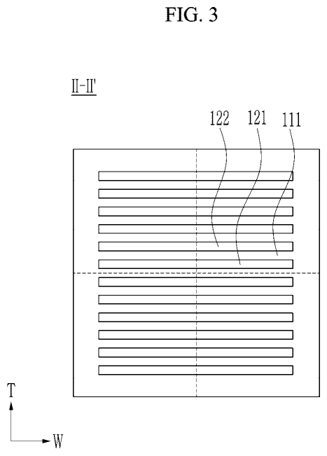

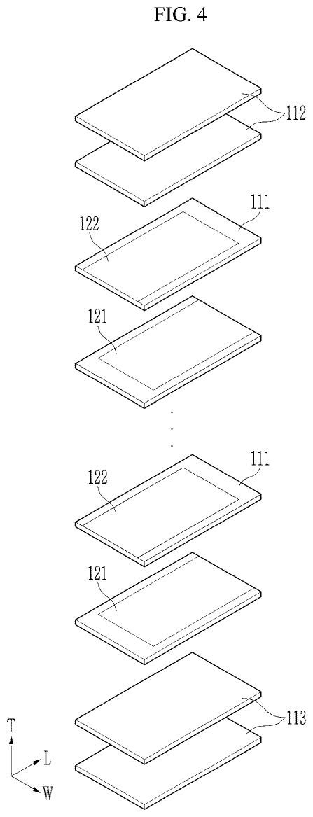

FIG. 1 is a perspective view showing a multilayer ceramic capacitor according to an embodiment, FIG. 2 is a cross-sectional view of the multilayer ceramic capacitor taken along line I-I′ of FIG. 1, FIG. 3 is a cross-sectional view of the multilayer ceramic capacitor taken along line II-II′ of FIG. 1, and FIG. 4 is an exploded perspective view illustrating the stacked structure by disassembling the capacitor body of the embodiment illustrated in FIG. 1.

The L-axis, W-axis, and T-axis shown in FIGS. 1 to 4 represent a length direction, a width direction, and a thickness direction of a capacitor body 110, respectively. Here, the thickness direction (T-axis direction) may be a direction perpendicular to the wide surface (major surface) of the sheet-shaped components, and may be used as the same concept as a stacking direction in which a dielectric layer 111 are stacked, for example. The length direction (L-axis direction) may be a direction extending parallel to the wide surface (major surface) of the sheet-shaped components, and may be approximately perpendicular to the thickness direction (T-axis direction). For example, the length direction (L-axis direction) may be the direction in which an external electrode 131 and a second external electrode 132 are positioned. The width direction (W-axis direction) may be a direction extending parallel to the wide surface (major surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 4, a multilayer ceramic capacitor according to an embodiment includes the capacitor body 110 and external electrodes 131 and 132 disposed on an outer surface of the capacitor body 110. The external electrodes 131 and 132 may include a first external electrode 131 and a second external electrode 132 disposed at opposite ends of the capacitor body 110 in the length direction (L-axis direction).

For example, the capacitor body 110 may have a roughly hexahedral shape.

For convenience of description of an embodiment, the two surfaces opposing each other in the thickness direction (T-axis direction) of the capacitor body 110 are referred to as first and second surfaces, the two surfaces connected to the first and second surfaces and opposing each other in the length direction (L-axis direction) are referred to as third and the fourth surfaces, and two surfaces connected to the first and second surfaces and to the third and fourth surfaces, and opposing each other in the width direction (W-axis direction) are referred to as the fifth and sixth surfaces.

As an example, the first surface, which is the lower surface, may be a surface facing the mounting direction. Additionally, the first to the sixth surfaces may be flat, but the embodiment is not limited thereto. For example, the first to the sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 includes a plurality of dielectric layers 111 and internal electrode layers 121 and 122. Specifically, the capacitor body 110 includes the plurality of dielectric layers 111 and a first internal electrode layer 121 and a second internal electrode layer 122 alternately disposed in the thickness direction (T-axis direction) interposing the dielectric layer 111.

At this time, the boundaries between adjacent dielectric layers 111 of the capacitor body 110 may be integrated to the extent that it is difficult to check without using a scanning electron microscope (SEM).

The capacitor body 110 may include an active region and cover regions 112 and 113.

The active region is a region where the dielectric layer 111 and the internal electrode layers 121 and 122 are alternately stacked, which contributes to forming capacitance of the multilayer capacitor 100. Specifically, the active region may be a region where the first internal electrode layer 121 or the second internal electrode layer 122 stacked along the thickness direction (T-axis direction) overlap.

The cover regions 112 and 113 are thickness-direction marginal portions, and may be positioned on the first and second surfaces of the active region in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include a side margin region.

The side margin region is a width-direction margin portion and may be located on opposite side ends of the active region in the width direction (W-axis direction), that is, on the fifth surface and the sixth surface, respectively. The side margin region may be formed according as, when the conductive paste layer for the internal electrode is applied on a surface of a dielectric green sheet, the dielectric green sheets, which are applied with the conductive paste layer only in a partial region of the surface of the dielectric green sheet and not applied with the conductive paste layer on both side surfaces of the surface of the dielectric green sheet, are stacked and then fired, but the forming method is not limited thereto.

The cover regions 112 and 113 and the side margin region serve to prevent damage to the first internal electrode layer 121 and the second internal electrode layer 122 due to physical or chemical stress.

### Dielectric Layer

According to an embodiment, the dielectric layer 111 includes at least two rare-earth elements. Specifically, the dielectric layer 111 includes a first element including at least one selected from cerium (Ce), gadolinium (Gd), samarium (Sm), and lanthanum (La); and a second element including at least one selected from erbium (Er), yttrium (Y), thulium (Tm), and ytterbium (Yb).

The first element and the second element may be derived from an additive mixed with a dielectric base material such as a barium titanate-based compound.

Typically, the dielectric layer of a multilayer ceramic capacitor implements performance such as reliability by adding various types of additives to a dielectric base material such as BaTiO₃. Among additives, rare-earth elements have a significant impact on changes in dielectric properties. Adding rare-earth elements controls the internal defect behavior of the dielectric layer, determines the structure of the dielectric grains, and brings about various effects such as improved temperature stability and enhanced reliability. However, in the case of Dy, which is mainly used as a rare-earth element, when added in excessive amounts, it combines with Si, another additive, to form a Si-based secondary phase such as Dy₂Si₂O₇, which adversely affects reliability.

Additionally, the Si-based secondary phase has a higher resistivity than BaTiO₃, and its dielectric constant is very small, less than 10. When two or more materials with different permittivity are combined, the electric field is concentrated in the material with the lower permittivity, so when the Si-based secondary phase exists in the dielectric layer, the electric field is concentrated at the grain boundary between the dielectric grains. Due to the phenomenon of electric field concentration at the grain boundary, the insulation resistance (IR) degradation is gradually accelerated, which has a negative effect on the reliability of the multilayer ceramic capacitor.

According to an embodiment, when the dielectric layer 111 includes the first element including at least one of Ce, Gd, Sm, and La and the second element including at least one of Er, Y, Tm, and Yb, as rare-earth elements, the formation of the Si-based secondary phase can be suppressed due to the difference in the solid solution properties of the rare-earth elements. Accordingly, the phenomenon of electric field concentration at grain boundaries can be reduced, thereby improving the reliability of the multilayer ceramic capacitor.

A molar ratio of the first element to the second element can be about 1.5 to about 4.0, for example about 1.6 to about 3.9, about 1.7 to about 3.8, about 1.8 to about 3.7, about 1.9 to about 3.6, or about 2.0 to about 3.5. When the molar ratio of the first element to the second element is within the above range, the Si-based secondary phase can remain in a minimal area within the dielectric layer, and accordingly, the phenomenon of electric field concentration at the grain boundary can be reduced, thereby improving the reliability of the multilayer ceramic capacitor. The molar ratio is the value obtained by dividing the content of the first element by the content of the second element. At this time, the contents of the first element and the second element can be expressed based on 100 parts by mole of titanium (Ti) present in the dielectric layer 111, respectively.

The dielectric layer 111 may further include barium (Ba) and titanium (Ti). Barium (Ba) and titanium (Ti) can be derived from a barium titanate-based compound, which is a dielectric base material.

The barium titanate-based compound has a high dielectric constant and contributes to forming the dielectric constant of a multilayer ceramic capacitor 100.

For example, the barium titanate-based compound may include at least one selected from BaTiO₃, Ba(Ti, Zr)O₃, Ba(Ti, Sn)O₃, (Ba, Ca)TiO₃, (Ba, Ca)(Ti, Zr)O₃, (Ba, Ca)(Ti, Sn)O₃, (Ba, Sr)TiO₃, (Ba, Sr)(Ti, Zr)O₃ and (Ba, Sr)(Ti, Sn)O₃.

Specifically, the content of the first element may be about 0.6 part by mole to about 8 parts by mole based on 100 parts by mole of titanium (Ti) in the dielectric layer 111, for example, about 1 part by mole to about 7.8 parts by mole, or about 2 parts by mole to about 7.5 parts by mole. When the content of the first element is within the above range, the generation of the Si-based secondary phase within the dielectric layer 111 can be suppressed, and thus the reliability of the multilayer ceramic capacitor can be improved.

Additionally, the content of the second element may be about 0.15 part by mole to about 5 parts by mole based on 100 parts by mole of titanium (Ti) in the dielectric layer 111, for example, about 0.2 part by mole to about 4.8 parts by mole, or about 0.3 part by mole to about 4.5 parts by mole. When the content of the second element is within the above range, the generation of the Si-based secondary phase within the dielectric layer 111 can be suppressed, and thus the reliability of the multilayer ceramic capacitor can be improved.

For example, the first element may include one or more selected from cerium (Ce) and samarium (Sm). Additionally, the second element may include one or more selected from erbium (Er) and yttrium (Y).

For example, the dielectric layer 111 may include cerium (Ce) as the first element and erbium (Er) as the second element. Additionally, the dielectric layer 111 may include samarium (Sm) as the first element and yttrium (Y) as the second element.

The dielectric layer 111 may further include one or more subcomponent selected from silicon (Si), aluminum (Al), magnesium (Mg), and manganese (Mn). The subcomponent may be derived from additives mixed together with the dielectric base material.

The components and contents in the dielectric layer 111 can be confirmed through electron probe microanalysis (EPMA) and laser ablation-inductively coupled plasma (LA-ICP) analysis. Other methods and/or tools appreciated by one of ordinary skill in the art, even if not described in the present disclosure, may also be used.

The components and contents may be confirmed via EPMA in the following ways:

After the multilayer ceramic capacitor 100 is placed into an epoxy mixing solution and then cured, the L-axis and the T-axis directional surface (LT surface) of the capacitor body 110 is polished to ½ depth in the W-axis direction to obtain a cross-sectional sample so that the active region where the dielectric layer 111 and the internal electrode layers 121 and 122 overlap can be observed. For example, when the active region is divided into three parts in the T-axis direction, i.e., the stacking direction, an upper region, a central region, and a lower region, a cross-sectional sample is obtained so that at least one dielectric layer and at least one internal electrode layer are visible in each region. EPMA analysis is performed on the obtained cross-sectional sample under the conditions of an acceleration voltage of 15 KV, a magnification of 10 k, and a residence time of 40 ms, so that the presence of elements existing in the dielectric layer 111 can be confirmed, and the content of each element can be confirmed from the signal intensity obtained during EPMA analysis.

Additionally, the components and contents may be confirmed via LA-ICP analysis in the following ways:

After the multilayer ceramic capacitor 100 is placed into an epoxy mixing solution and then cured, the L-axis and the T-axis directional surface (LT surface) of the capacitor body 110 is polished to ½ depth in the W-axis direction to obtain a cross-sectional sample so that the active region where the dielectric layer 111 and the internal electrode layers 121 and 122 overlap can be observed. For example, when the active region is divided into three parts in the T-axis direction, i.e., the stacking direction, an upper region, a central region, and a lower region, a cross-sectional sample is obtained so that at least one dielectric layer and at least one internal electrode layer are visible in each region. A solid sample is obtained from the dielectric layer of the obtained cross-sectional sample and LA-ICP analysis is performed. For example, LA-ICP analysis is a method of checking the content of each element by introducing an analysis sample ablated by laser irradiation into an ICP device via a carrier gas. LA-ICP analysis can be performed using a gas flow of 0.5 L/min to 1.0 L/min of Ag/He and a laser with a wavelength of 213 nm or 266 nm. Applied Spectra's J200 equipment can used as LA, and Thermo Fisher's iCAP RQ equipment can used as ICP.

The presence of elements in the dielectric layer 111 can be confirmed through LA-ICP analysis, and the content of each element can be confirmed from the obtained signal intensity. For example, from LA-ICP analysis, not only can the first element such as Ti, Ce, etc. and the second element such as Er, etc. be identified, but also the content of the first element based on 100 parts by mole of Ti and the content of the second element based on 100 parts by mole of Ti can be identified, and from this, the molar ratio of the first element to the second element can be calculated. For example, by selecting two dielectric layers in each region from the upper region, the central region, and the lower region within the active region, and designating two arbitrary points in the selected dielectric layers, the average value of the content of the first element at a total of 12 points, the average value of the content of the second element at a total of 12 points, and the average value of the molar ratio of the first element to the second element at a total of 12 points can be obtained, respectively.

The dielectric layer 111 may include a Si-based secondary phase.

The Si-based secondary phase may refer to a new phase precipitated after a dielectric green sheet stack is fired. In other words, when a dielectric green sheet stack obtained by using a dielectric slurry prepared by mixing a barium titanate-based main component and a subcomponent corresponding to an additive is fired, additives such as rare-earth elements may not be dissolved into a lattice of the barium titanate but may be precipitated in a form of a secondary phase.

The Si-based secondary phase may include silicon (Si); and at least one selected from cerium (Ce), gadolinium (Gd), samarium (Sm), lanthanum (La), erbium (Er), yttrium (Y), thulium (Tm), ytterbium (Yb), aluminum (Al), magnesium (Mg), and manganese (Mn).

Specifically, the Si-based secondary phase may include at least one selected from CeₓEr_{y}Si₂O₇ (0≤x≤2, 0≤y≤2), CeₓEr_{y}SiO₅ (0≤x≤2, 0≤y≤2), a Si—O—Al bond-containing compound, a Si—O—Mg bond-containing compound, and a Si—O—Mn bond-containing compound.

The Si-based secondary phase may include silicon (Si) in an amount of about 20 mol % to about 80 mol % based on a total amount of the Si-based secondary phase, for example, about 25 mol % to about 75 mol %, or about 30 mol % to about 70 mol %. When Si is included within the above range in the Si-based secondary phase, the area occupied by the Si-based secondary phase can be formed to a minimum.

The area occupied by the Si-based secondary phase can be greater than 0 and less than or equal to about 2.0 μm² based on an area of 10 μm×10 μm of the active region, for example, about 0.1 μm² to about 1.9 μm², about 0.2 μm² to about 1.8 μm², about 0.3 μm² to about 1.7 μm², about 0.4 μm² to about 1.6 μm², about 0.5 μm² to about 1.5 μm², or about 0.6 μm² to about 1.4 μm². When the area of the Si-based secondary phase is within the above range, the phenomenon of electric field concentration at the grain boundary is reduced, so that the reliability of the multilayer ceramic capacitor can be improved. That is, when the area of the Si-based secondary phase exceeds about 2.0 μm², the reliability of the multilayer ceramic capacitor may deteriorate as the insulation resistance (IR) degradation is accelerated due to the electric field concentration phenomenon at the grain boundary.

Not only can the Si-based secondary phase within the dielectric layer 111 be confirmed using transmission electron microscope-energy dispersive spectroscopy (TEM-EDS), but the area of the Si-based secondary phase can also be measured.

After the multilayer ceramic capacitor 100 is placed into an epoxy mixing solution and then cured, the L-axis and the T-axis directional surface (LT surface) of the capacitor body 110 is polished to ½ depth in the W-axis direction to obtain a cross-sectional sample so that the active region where the dielectric layer 111 and the internal electrode layers 121 and 122 overlap can be observed. For example, when the active region is divided into three parts in the T-axis direction, i.e., the stacking direction, an upper region, a central region, and a lower region, a cross-sectional sample is obtained so that at least one dielectric layer and at least one internal electrode layer are visible in each region. Next, the obtained cross-sectional sample is measured using a transmission electron microscope (TEM). TEM can be measured, for example, using a focused ion beam (FIB) under conditions of an acceleration voltage of 200 kV and a magnification of about 10 k. The TEM image of the cross-sectional sample is analyzed by energy dispersive spectroscopy (EDS) to confirm the Si-based secondary phase and measure the area of the Si-based secondary phase. The Si-based secondary phases may appear as clumps of parts where Si is detected in the analyzed image. In addition, the area of the Si-based secondary phase can be obtained by calculating the area of the Si-based secondary phase based on an area of 10 μm×10 μm in each region, for example, in the upper region, central region, and lower region within the active region, and then calculating the average value from a total of three locations. Other methods and/or tools appreciated by one of ordinary skill in the art, even if not described in the present disclosure, may also be used.

An average thickness (average length in the T-axis direction) of the dielectric layer 111 may be about 0.1 μm to about 8.0 μm, and for example, may be about 0.1 μm to about 6.0 μm. When the average thickness of the dielectric layer 111 is within the above range, the reliability of the multilayer ceramic capacitor may be improved.

The average thickness of the dielectric layer 111 may be measured by placing the multilayer capacitor 100 in an epoxy mixing solution, curing it, polishing it, and then ion milling it, and then analyzing it using a scanning electron microscope (SEM). The scanning electron microscope can be measured under conditions of, for example, 10 KV and a magnification of 100 times, and can be measured so that at least 1 layer, 3 layers, 5 layers, or 10 layers of the dielectric layer 111 are visible in the active region where the dielectric layer 111 and the internal electrode layers 121 and 122 overlap. The average thickness of the dielectric layer can be obtained by taking the central point of the length direction (L-axis direction) or width direction (W-axis direction) of the dielectric layer 111 as a reference point in the scanning electron microscope (SEM) image, and taking the mean value of the thickness of the dielectric layer 111 at 10 points spaced apart from the reference point at a predetermined interval. The intervals of the 10 points may be adjusted depending on the scale of the SEM image, and may be, for example, about 1 μm to about 100 μm, about 1 μm to about 50 μm, or about 1 μm to about 10 μm. At this time, all 10 points must be positioned within the dielectric layer 111, and if all 10 points are not positioned within the dielectric layer 111, the position of the reference point may be changed, or the interval between the 10 points may be adjusted. In addition, by extending this average value measurement to 10 dielectric layers and measuring the average value, the average thickness of the dielectric layer can be more generalized.

### Internal Electrode Layer

The internal electrode layers 121 and 122, i.e., the first internal electrode layer 121 and the second internal electrode layer 122, are electrodes having different polarities and are alternately disposed to face each other along the T-axis direction with the dielectric layer 111 interposed between them, and one end may be exposed through the third and fourth surfaces of the capacitor body 110, respectively.

The first internal electrode layer 121 and the second internal electrode layer 122 may be electrically insulated from each other by a dielectric layer 111 disposed in the middle.

The ends of the first internal electrode layer 121 and the second internal electrode layer 122, which are alternately exposed through the third and fourth surfaces of the capacitor body 110, may be electrically connected to the first external electrode 131 and the second external electrode 132, respectively.

The internal electrode layers 121 and 122 include a conductive metal, and may include, for example, one or more selected from metal such as Ni, Cu, Ag, Pd, Au, etc. and an alloy thereof.

Additionally, the internal electrode layers 121 and 122 may include dielectric particles having the same composition as the ceramic material included in the dielectric layer 111.

The internal electrode layers 121 and 122 can be formed using a conductive paste including the conductive metal. The printing method for the conductive paste can be either screen printing or gravure printing.

Each average thickness of the first internal electrode layer 121 and the second internal electrode layer 122 may be about 0.1 μm to about 2 μm.

The average thickness of the first internal electrode layer 121 and the second internal electrode layer 122 may be measured by a scanning electron microscope (SEM) analysis. Specifically, the average thickness of the internal electrode layers can be obtained by taking the central point of the length direction (L-axis direction) or width direction (W-axis direction) of each of the internal electrode layers 121 and 122 as a reference point in the SEM image of the cross-sectional sample obtained by the same method as the method of measuring the average thickness of the dielectric layer 111, and taking the mean value of the thickness of each of the internal electrode layers 121 and 122 at 10 points spaced apart from the reference point at a predetermined interval. The intervals of the points may be adjusted depending on the scale of the SEM image, and may be, for example, about 1 μm to about 100 μm, about 1 μm to about 50 μm, or about 1 μm to about 10 μm. At this time, all 10 points must be positioned within each of the internal electrode layers 121 and 122, and if all 10 points are not positioned within each of the internal electrode layers 121 and 122, the position of the reference point may be changed, or the interval between the 10 points may be adjusted. In addition, by extending this average value measurement to 10 internal electrode layers and measuring the average value, the average thickness of the internal electrode layers can be more generalized.

The capacitor body 110 may be formed by firing a stacking structure in which the plurality of dielectric layers 111 and internal electrode layers 121 and 122 are stacked.

### External Electrode

The external electrodes 131 and 132, i.e., the first external electrode 131 and the second external electrode 132 are provided with voltages of different polarities and may be electrically connected with exposed portions of the first internal electrode layer 121 and the second internal electrode layer 122, respectively.

According to the above configuration, when a predetermined voltage is applied to the first external electrode 131 and the second external electrode 132, charges are accumulated between the first internal electrode layer 121 and the second internal electrode layer 122 facing each other. At this time, the capacitance of the multilayer capacitor 100 is proportional to the overlapping area of the first internal electrode layer 121 and the second internal electrode layer 122 that overlap each other along the T-axis direction in the active region.

The first external electrode 131 and the second external electrode 132 may include, respectively, first and second connection portions disposed on the third and fourth surfaces of the capacitor body 110 and connected to the first internal electrode layer 121 and the second internal electrode layer 122, and first and second band portions disposed on edges where the third and fourth surfaces of the capacitor body 110 meet the first and second surfaces or the fifth and sixth surfaces.

The first and second band portions may extend, respectively, from the first and second connection portions to portions of the first and second surfaces or the fifth and sixth surfaces of the capacitor body 110. The first and second band portions may serve to improve the adhesion strength of the first external electrode 131 and the second external electrode 132.

The external electrodes 131 and 132 may include a sintered metal layer in contact with the capacitor body 110, a conductive resin layer disposed to cover the sintered metal layer, and a plating layer disposed to cover the conductive resin layer.

The sintered metal layer may include a conductive metal and glass.

The conductive metal may include one or more selected from copper (Cu), nickel (Ni), silver (Ag), palladium (Pd), gold (Au), platinum (Pt), tin (Sn), tungsten (W), titanium (Ti), lead (Pb), and an alloy thereof, and for example, the term copper (Cu) may include a copper (Cu) alloy. When the conductive metal includes copper (Cu), metals other than copper (Cu) may be included in an amount of less than or equal to about 5 parts by mole based on 100 parts by mole of copper (Cu).

The glass may include a composition of mixed oxides, for example, one or more selected from the group consisting of silicon oxide, boron oxide, aluminum oxide, transition metal oxide, alkali metal oxide, and alkaline earth metal oxide. The transition metal may be selected from a group consisting of zinc (Zn), titanium (Ti), copper (Cu), vanadium (V), manganese (Mn), iron (Fe) and nickel (Ni), the alkali metal may be selected from a group consisting of lithium (Li), sodium (Na) and potassium (K), and the alkaline-earth metal may be at least one selected from a group consisting of magnesium (Mg), calcium (Ca), strontium (Sr) and barium (Ba).

Optionally, the conductive resin layer may be formed on the sintered metal layer, and for example, may be formed in the shape that completely covers the sintered metal layer. Meanwhile, the external electrodes 131 and 132 may not include the sintered metal layer, and in this case, the conductive resin layer may directly contact the capacitor body 110.

The conductive resin layer extends to the first and second surfaces or the fifth and sixth surfaces of the capacitor body 110, and the length of the region (i.e., band portion) where the conductive resin layer is extended and disposed to the first and second surfaces or the fifth and sixth surfaces of the capacitor body 110 may be longer than the length of the region (i.e., band portion) where the sintered metal layer is extended and disposed to the first and second surfaces or the fifth and sixth surfaces of the capacitor body 110. That is, the conductive resin layer may be formed on the sintered metal layer, and may be formed in the shape that completely covers the sintered metal layer.

The conductive resin layer may include a resin and a conductive metal.

The resin included in the conductive resin layer may be implemented by a material which has adhesive properties and shock absorption properties and is able to form a paste when mixed with the conductive metal powder, but is not limited thereto. For example, the resin may include a phenolic resin, an acrylic resin, a silicone resin, an epoxy resin, or a polyimide resin.

The conductive metal included in the conductive resin layer serves to be electrically connected to the internal electrode layers 121 and 122 or the sintered metal layer.

The conductive metal included in the conductive resin layer may have a spherical shape, a flake shape, or a combination thereof. That is, the conductive metal may be formed only in flake form, only in spherical form, or in a mixed form of flake form and spherical form.

Here, the spherical shape may also include a shape that is not a perfect spherical shape, for example, a shape in which the length ratio of the major axis and the minor axis (major axis/minor axis) is less than or equal to about 1.45. Flake shape powder refers to a powder with a flat and elongated shape, and is not particularly limited. But for example, the length ratio of the major axis and the minor axis (major axis/minor axis) may be greater than or equal to about 1.95.

The external electrodes 131 and 132 may further include the plating layer disposed outside the conductive resin layer.

The plating layer may include nickel (Ni), copper (Cu), tin (Sn), palladium (Pd), platinum (Pt), gold (Au), silver (Ag), tungsten (W), titanium (Ti), or lead (Pb), either alone or in an alloy thereof. For example, the plating layer may be a nickel (Ni) the plating layer or a tin (Sn) the plating layer, may be a form in which the nickel (Ni) the plating layer and the tin (Sn) the plating layer are sequentially stacked, or may be a form in which the tin (Sn) the plating layer, the nickel (Ni) the plating layer, and the tin (Sn) the plating layer are sequentially stacked. In addition, the plating layer may include a plurality of nickel (Ni) the plating layers and/or a plurality of tin (Sn) the plating layers.

The plating layer may improve mountability to the substrate, structural reliability, durability to the outside, heat resistance, and equivalent series resistance (ESR) of the multilayer ceramic capacitor 100.

### Method of Manufacturing Multilayer Ceramic Capacitor

Hereinafter, a method of manufacturing the multilayer ceramic capacitor 100 according to an embodiment will be described.

A multilayer ceramic capacitor 100 according to an embodiment may be manufactured by preparing a dielectric slurry using a mixture including a barium titanate-based compound, a first element-containing compound, and a second element-containing compound; manufacturing a dielectric green sheet using the dielectric slurry and forming a conductive paste layer on a surface of the dielectric green sheet; manufacturing a dielectric green sheet stack by stacking a plurality of the dielectric green sheets on which the conductive paste layer is formed; manufacturing a capacitor body including a dielectric layer and an internal electrode layer by firing the dielectric green sheet stack; and forming an external electrode on a surface of the capacitor body.

The first element-containing compound may be a compound containing a first element including at least one selected from cerium (Ce), gadolinium (Gd), samarium (Sm), and lanthanum (La). Additionally, the second element-containing compound may be a compound containing a second element including at least one selected from erbium (Er), yttrium (Y), thulium (Tm), and ytterbium (Yb).

The first element-containing compound and the second element-containing compound may be mixed so that a molar ratio of the first element and the second element is about 1.5:1 to about 4:1, for example a molar ratio of about 1.6:1 to about 3.9:1, a molar ratio of about 1.7:1 to about 3.8:1, a molar ratio of about 1.8:1 to about 3.7:1, a molar ratio of about 1.9:1 to about 3.6:1, or a molar ratio of about 2.0:1 to about 3.5:1. When the first element-containing compound and the second element-containing compound are mixed within the above range, the Si-based secondary phase can remain in a minimum area within the dielectric layer, and thus a multilayer ceramic capacitor with excellent reliability can be obtained. At this time, the contents of the first element and the second element can be expressed based on 100 parts by mole of titanium (Ti) of the barium titanate-based compound, respectively.

The first element-containing compound and the second element-containing compound may each be an oxide, a nitride, a salt compound, or a compound in the form of a sol dispersed in an organic solvent, for example, a nitride.

When preparing the dielectric slurry, the mixture may further include one or more additives selected from a silicon (Si)-containing compound, an aluminum (Al)-containing compound, a magnesium (Mg)-containing compound, and a manganese (Mn)-containing compound.

The additive may be included in an amount of more than 0 parts by mole to about 4 parts by mole or less, for example, about 0.1 part by mole to about 3.8 parts by mole based on 100 parts by mole of the barium titanate-based compound.

The silicon (Si)-containing compound, the aluminum (Al)-containing compound, the magnesium (Mg)-containing compound and the manganese (Mn)-containing compound may each be an oxide, a nitride, a salt compound, or a compound in the form of a sol dispersed in an organic solvent, for example, an oxide.

The dielectric slurry may be prepared by additionally mixing additives such as a dispersant, a binder, a plasticizer, a lubricant, an antistatic agent, and a solvent.

The dispersant may include for example at least one selected from a phosphoric acid ester-based dispersant and a polycarboxylic acid-based dispersant. The dispersant may be mixed in an amount of about 0.1 part by weight to about 5 parts by weight, for example, about 0.3 part by weight to about 3 parts by weight based on 100 parts by weight of the barium titanate-based compound. When the dispersant is mixed within the above content range, the dielectric slurry shows excellent dispersibility, and the amount of impurities included in the manufactured dielectric layer may be reduce.

The binder may be, for example, an acrylic resin, a polyvinyl butyl resin, a polyvinyl acetal resin, an ethylcellulose resin, or the like. The binder may be added in an amount of about 0.1 part by weight to about 50 parts by weight, for example, about 3 parts by weight to about 30 parts by weight, based on 100 parts by weight of the barium titanate-based compound. When the binder is mixed within the above content range, the dielectric slurry shows excellent dispersibility, and the amount of impurities included in the manufactured dielectric layer may be reduced.

The plasticizer may be, for example, a phthalic acid-based compound such as dioctyl phthalate, benzyl butyl phthalate, dibutyl phthalate, dihexyl phthalate, di(2-ethylhexyl) phthalate, and di(2-ethylbutyl) phthalate; an adipic acid-based compound such as dihexyl adipate and di(2-ethylhexyl) adipate; a glycol-based compound such as ethylene glycol, diethylene glycol, and triethylene glycol; a glycol ester-based compound such as triethylene glycol dibutyrate, triethylene glycol di(2-ethylbutyrate), and triethylene glycol di(2-ethylhexanoate); and the like. The plasticizer may be added in an amount of about 0.1 part by weight to about 20 parts by weight, for example, about 1 part by weight to about 10 parts by weight, based on 100 parts by weight of the barium titanate-based compound. When the plasticizer is mixed within the above content range, the dielectric slurry shows excellent dispersibility, and the amount of impurities included in the manufactured dielectric layer may be reduced.

The solvent may be an aqueous solvent such as water; an alcohol-based solvent such as ethanol, methanol, benzyl alcohol, and methoxyethanol; a glycol-based solvent such as ethylene glycol and diethylene glycol; a ketone-based solvent such as acetone, methyl ethyl ketone, methyl isobutyl ketone, and cyclohexanone; an ester-based solvent such as butyl acetate, ethyl acetate, carbitol acetate, and butylcarbitol acetate; an ether-based solvent such as methyl cellosolve, ethyl cellosolve, butyl ether, and tetrahydrofuran; an aromatic-based solvent such as benzene, toluene, and xylene, or the like. The solvent may be, for example, an alcohol-based solvent or aromatic-based solvent, considering solubility or dispersibility of various additives included in the dielectric slurry. The solvent may be mixed in an amount of about 50 parts by weight to about 1000 parts by weight, and for example, about 100 parts by weight to about 500 parts by weight based on 100 parts by weight of the barium titanate-based compound. When the solvent is mixed within the above content range, the dielectric slurry components may be sufficiently mixed, and subsequent removal of the solvent is easy.

The dielectric slurry described above may be mixed by using a wet ball mill or a stirred mill. When using the zirconia balls in the wet ball mill, a plurality of zirconia balls with a diameter of about 0.1 mm to about 10 mm may be used for wet mixing for about 8 hours to about 48 hours, or about 10 hours to about 24 hours.

The prepared dielectric slurry is formed into a dielectric layer after firing.

As a method of molding the prepared the dielectric slurry into a sheet shape, a tape molding method such as a doctor blade method, a calendar roll method, etc. may be used, for example, an on-roll molding coater with a head discharge method, and a dielectric green sheet may be obtained by drying the molded body afterward.

To form a conductive paste layer that becomes an internal electrode layer after firing, a conductive paste can be prepared by mixing a conductive powder made of a conductive metal or an alloy thereof, a binder, and a solvent. Additionally, barium titanate-based powder may be mixed in as a co-material if necessary. The co-material may act to inhibit the sintering of the conductive powder during the firing process. A conductive paste layer is formed by applying the conductive paste in a predetermined pattern on a surface of the dielectric green sheet using various printing methods such as screen printing or a transfer method.

The conductive powder may be include nickel (Ni) or a nickel (Ni) alloy.

Next, a dielectric green sheet stack is prepared by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is positioned on the upper and lower surfaces of the dielectric green sheet stack in the stacking direction.

The cutting of the manufactured dielectric green sheet stack to a predetermined size by dicing or the like may optionally be performed.

Additionally, the dielectric green sheet stack may be solidified and dried to remove plasticizers, etc., if necessary, and after solidified and dried, the dielectric green sheet stack may be barrel polished using a horizontal centrifugal barrel machine, and the like. In barrel polishing, the dielectric green sheet stack is placed into a barrel container with media and polishing liquid, and rotational motion or vibration is applied to the barrel container, thus unnecessary parts, such as burrs generated during cutting, may be polished. Additionally, after barrel polishing, the dielectric green sheet stack may be washed with a cleaning solution such as water, and dried.

Subsequently, the capacitor body may be manufactured after binder removal treatment, that is, calcinating and firing of the dielectric green sheet stack.

The conditions for binder removal may be appropriately adjusted depending on the components of the dielectric layer or the internal electrode layer. For example, the rate of temperature rise during binder removal treatment may be about 5° C./hour to about 300° C./hour, the support temperature may be about 180° C. to about 400° C., and the temperature holding time may be about 0.5 hour to about 24 hours. The binder removal may be performed under an air atmosphere or a reducing atmosphere.

The conditions of the firing treatment may be appropriately adjusted depending on the main component composition of the dielectric layer or the main component composition of the internal electrode layer. For example, the firing may be performed at a temperature of about 1100° C. to about 1400° C., for example, at a temperature of about 1200° C. to about 1350° C. Additionally, the firing may be performed for about 0.5 hour to about 8 hours, for example, about 1 hour to about 3 hours. Additionally, the firing may be performed in a reducing atmosphere, for example, in a humidified mixed gas of nitrogen and hydrogen, and may be performed under conditions such as a hydrogen concentration of 1.0% or less. When the internal electrode layer includes nickel (Ni) or a nickel (Ni) alloy, the oxygen partial pressure in the firing atmosphere can be 1.0×10⁻¹⁴ MPa to 1.0×10⁻¹⁰ MPa.

After firing, annealing may be performed as needed. The annealing is a treatment to re-oxidize the dielectric layer, and annealing may be performed if firing is performed in a reducing atmosphere. The conditions of the annealing treatment may also be appropriately adjusted depending on the components of the dielectric layer. For example, the annealing temperature may be about 950° C. to about 1150° C., the time may be about 0 to about 20 hours, and the rate of temperature rise may be about 50° C./hour to about 500° C./hour. The annealing atmosphere may be a humidified nitrogen gas (N₂) atmosphere, and an oxygen partial pressure may be about 1.0×10⁻⁹ MPa to about 1.0×10⁻⁵ MPa.

In binder removal treatment, firing treatment, or annealing treatment, for example, a wetter may be used to humidify nitrogen gas or mixed gas. In this case, the water temperature may be about 5° C. to about 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the prepare capacitor body 110. By performing this surface treatment, the ends of the first internal electrode layer and the second internal electrode layer may be exposed to the outermost surfaces of the third and fourth surfaces, and thus the electrical connection between the first external electrode layer and the second external electrode layer, and the first internal electrode and the second internal electrode may be improved, alloy portions may be easily formed.

Subsequently, the external electrode is formed on a surface of the manufactured capacitor body 110.

As an example, a paste for forming the sintered metal layer may be applied to the external electrode and then sintered to form the sintered metal layer.

The paste for forming the sintered metal layer may include a conductive metal and glass. Since the description of the conductive metal and glass is the same as described above, repetitive description will be omitted. Additionally, the paste for forming the sintered metal layer may optionally include a binder, solvent, dispersant, plasticizer, oxide powder, and the like. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body 110 may include various printing methods such as dip method and screen printing, application method using a dispenser, etc., and spraying method using spray. The paste for forming the sintered metal layer may be applied to at least the third and fourth surfaces of the capacitor body 110, and optionally applied to a part of the first, second, fifth, or the sixth surfaces on which the band portions of the first and second external electrodes are formed.

Thereafter, the capacitor body 110 applied with the paste for forming the sintered metal layer is dried, and sintered at a temperature of about 700° C. to about 1000° C. for about 0.1 hour to about 3 hours, to form the sintered metal layer.

Optionally, a paste for forming the conductive resin layer is applied on an outer surface of the obtained capacitor body 110 and then cured, to form the conductive resin layer.

The paste for forming the conductive resin layer may include a resin and, optionally, a conductive metal or a non-conductive filler. Since the description of the conductive metal and resin is the same as described above, repetitive description will be omitted. Additionally, the paste for forming the conductive resin layer may optionally include a binder, a solvent, a dispersant, a plasticizer, an oxide powder, and the like. The binder may be, for example, ethylcellulose, acrylic, butyral, etc., and the solvent may be an organic solvent or aqueous solvent such as terpineol, butylcarbitol, alcohol, methyl ethyl ketone, acetone, and toluene.

For example, the conductive resin layer may be formed by dipping the capacitor body 110 in the paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, a plating layer is formed on the outside of the conductive resin layer.

For example, the plating layer may be formed by a plating method, sputtering, or electrolytic plating (electric deposition).

Hereinafter, the embodiments are illustrated in more detail with reference to examples. However, these examples are exemplary, and the scope of claims is not limited thereto.

### (Manufacturing of Multilayer Ceramic Capacitors)

### Example 1

A dielectric slurry was prepared by mixing barium titanate (BaTiO₃), cerium nitride (CeN), erbium nitride (ErN), and silicon dioxide (SiO₂). At this time, CeN and ErN were mixed at a molar ratio of 1.5:1 based on 100 parts by mole of BaTiO₃. Additionally, SiO₂ was mixed in an amount of 1.4 parts by mole based on 100 parts by mole of BaTiO₃.

The dielectric slurry was prepared by mechanical milling after adding ethanol/toluene, a wetting dispersant, and polyvinyl butyral as a binder together using zirconia balls (ZrO₂ balls) as a dispersion medium.

The dielectric slurry was used by using a head discharge type on-roll forming coater to manufacture a dielectric green sheet.

A conductive paste layer including nickel (Ni) was printed on the surface of the dielectric green sheet, and the dielectric green sheets on which the conductive paste layers were formed were stacked and pressed to manufacture a dielectric green sheet stack.

Each dielectric green sheet stack was calcined at a temperature of 400° C. or less in a nitrogen atmosphere, and then fired under the conditions of a firing temperature 1300° C. or lower and a hydrogen concentration of 1.0% H₂ or lower.

Next, a multilayer ceramic capacitor was manufactured through processes such as a formation of external electrodes and plating.

### Example 2

A multilayer ceramic capacitor was manufactured in the same manner as in Example 1 except that CeN and ErN were mixed in a molar ratio of 3:1.

### Example 3

A multilayer ceramic capacitor was manufactured in the same manner as in Example 1 except that CeN and ErN were mixed in a molar ratio of 4:1.

### Example 4

A dielectric slurry was prepared by mixing barium titanate (BaTiO₃), samarium nitride (SmN), yttrium nitride (YN), and silicon dioxide (SiO₂). At this time, SmN and YN were mixed at a molar ratio of 3:1 based on 100 parts by mole of BaTiO₃. Additionally, SiO₂ was mixed in an amount of 1.4 parts by mole based on 100 parts by mole of BaTiO₃.

Next, a multilayer ceramic capacitor was manufactured using the dielectric slurry in the same manner as in Example 1.

### Comparative Example 1

A dielectric slurry was prepared by mixing barium titanate (BaTiO₃), dysprosium oxide (Dy₂O₃), terbium oxide (Tb₃O₄), and silicon dioxide (SiO₂). At this time, Dy₂O₃ and Tb₃O₄ were mixed at a molar ratio of 3:1 based on 100 parts by mole of BaTiO₃. Additionally, SiO₂ was mixed in an amount of 1.4 parts by mole based on 100 parts by mole of BaTiO₃.

Next, a multilayer ceramic capacitor was manufactured using the dielectric slurry in the same manner as in Example 1.

### Comparative Example 2

A multilayer ceramic capacitor was manufactured in the same manner as in Example 1 except that CeN and ErN were mixed in a molar ratio of 1.3:1.

### Comparative Example 3

A multilayer ceramic capacitor was manufactured in the same manner as in Example 1 except that CeN and ErN were mixed in a molar ratio of 4.2:1.

### Evaluation 1: EPMA Analysis

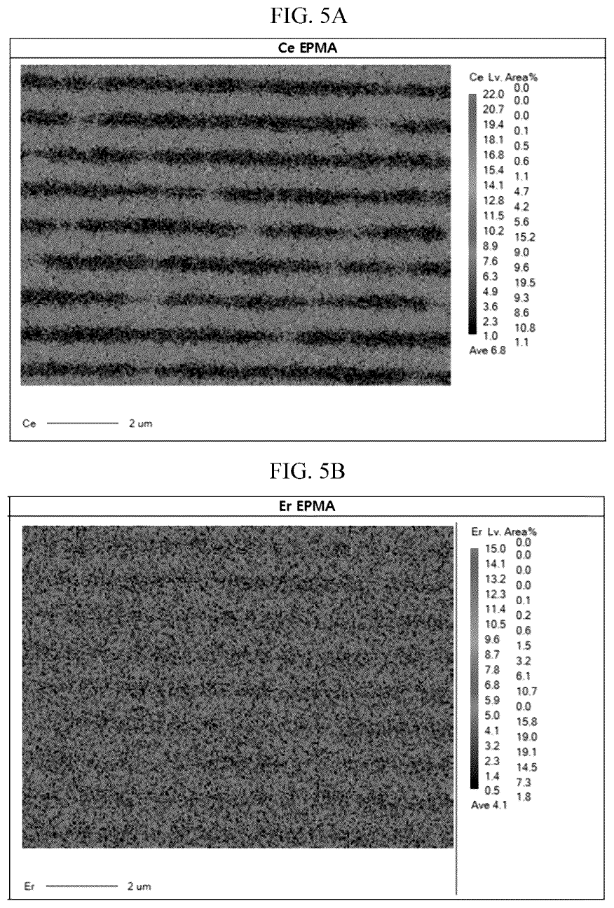

Electron probe microanalysis (EPMA) analysis was performed on the multilayer ceramic capacitor manufactured in Example 1 using the following method, and the results are shown in FIGS. 5A and 5B.

After the multilayer ceramic capacitor was placed into an epoxy mixing solution and then cured, the L-axis and the T-axis directional surface (LT surface) of the capacitor body was polished to ½ depth in the W-axis direction to obtain a cross-sectional sample so that the active region where the dielectric layer and the internal electrode layer overlap can be observed. Specifically, when the active region was divided into three parts in the T-axis direction, i.e., the stacking direction, the upper region, the central region, and the lower region, a cross-sectional sample was obtained so that at least one dielectric layer and at least one internal electrode layer were visible in each region. EPMA analysis was performed on the obtained cross-sectional sample under the conditions of an acceleration voltage of 15 KV, a magnification of 10 k, and a residence time of 40 ms.

FIGS. 5A and 5B are electron probe microanalysis (EPMA) images of the active region according to Example 1.

Referring to FIGS. 5A and 5B, it can be confirmed that Ce and Er existed in the dielectric layer of the active region in the case of Example 1.

### Evaluation 2: LA-ICP Analysis

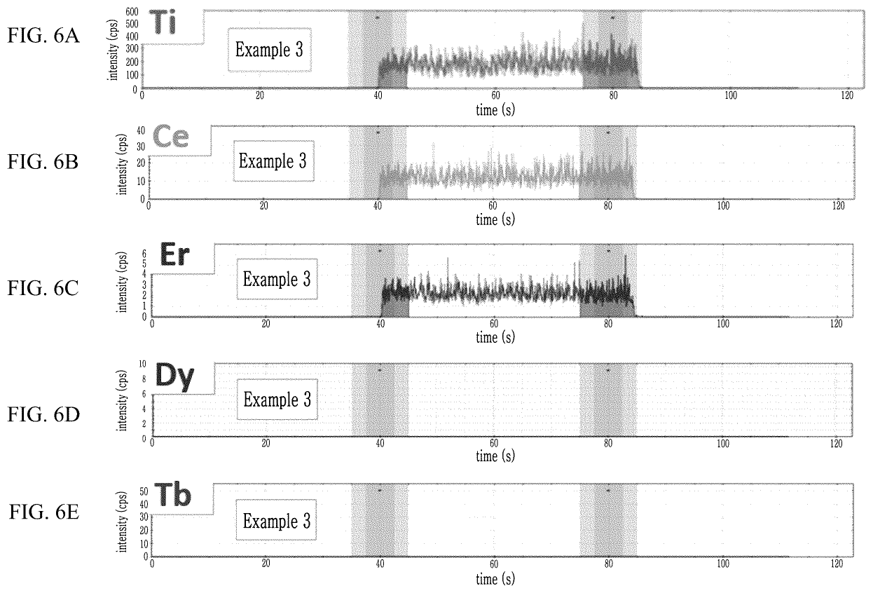

Laser ablation-inductively coupled plasma (LA-ICP) analysis was performed on the multilayer ceramic capacitors manufactured in Examples 1 to 4 and Comparative Examples 1 to 3 by the following method, and the results are shown in FIGS. 6A to 6E and Table 1 below.

After each multilayer ceramic capacitor was placed into an epoxy mixing solution and then cured, the L-axis and the T-axis directional surface (LT surface) of the capacitor body was polished to ½ depth in the W-axis direction to obtain a cross-sectional sample so that the active region where the dielectric layer and the internal electrode layer overlap can be observed. Specifically, when the active region was divided into three parts in the T-axis direction, i.e., the stacking direction, the upper region, the central region, and the lower region, a cross-sectional sample was obtained so that at least one dielectric layer and at least one internal electrode layer were visible in each region. A solid sample was obtained from the dielectric layer of the obtained cross-sectional sample and LA-ICP analysis was performed. At this time, Applied Spectra's J200 equipment was used as LA, and Thermo Fisher's iCAP RQ equipment was used as ICP, and the analysis was performed using a gas flow of 0.5 L/min to 1.0 L/min of Ag/He, and a laser with a wavelength of 213 nm or 266 nm.

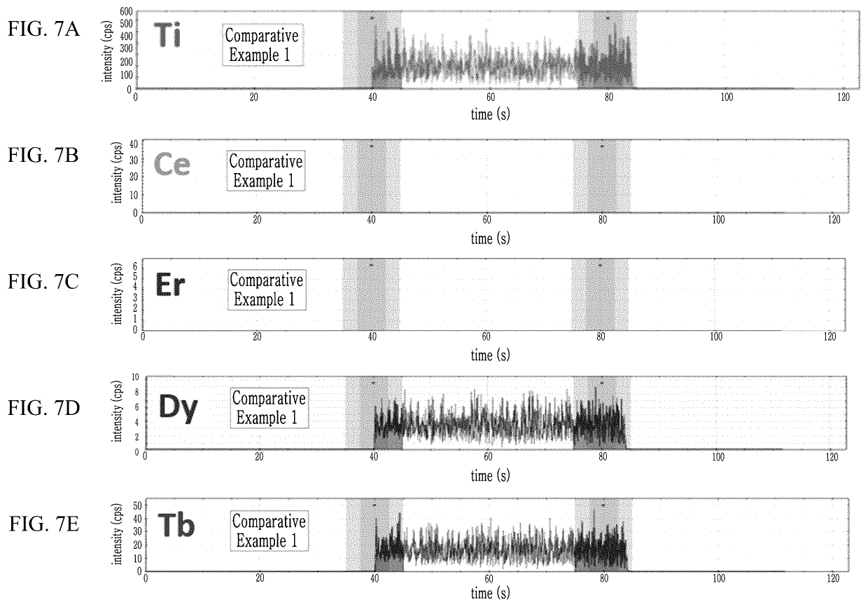

FIGS. 6A to 6E are each a laser ablation-induced coupled plasma (LA-ICP) analysis image of the dielectric layer according to Example 3, and FIGS. 7A to 7E are each a laser ablation-induced coupled plasma (LA-ICP) analysis image of the dielectric layer according to Comparative Example 1.

Referring to FIGS. 6A to 6E, in the case of Example 3, it can be confirmed that Ti, Ce, and Er were present in the dielectric layer, and in the case of Comparative Example 1, it can be confirmed that Ti, Dy, and Tb were present in the dielectric layer.

Additionally, the molar ratio between elements was measured from the signal intensity obtained from LA-ICP analysis, and the results are shown in Table 1 below.

The molar ratio between elements was obtained by selecting two dielectric layers for each region in the upper region, central region, and lower region within the active region, and designating two random points in each selected dielectric layer, and taking the average value of the molar ratio between elements at a total of 12 points. At this time, the content of each element was expressed with Ti 100 parts by mole as a reference.

TABLE 1

| | Molar ratio |
|---|---|
| | between elements |
| Example 1 | Molar ratio of Ce/Er 1.5 |
| Example 2 | Molar ratio of Ce/Er 3.0 |
| Example 3 | Molar ratio of Ce/Er 4.0 |
| Example 4 | Molar ratio of Sm/Y 3.0 |
| Comparative | Molar ratio of Dy/Tb 3.0 |
| Example 1 | |
| Comparative | Molar ratio of Ce/Er 1.3 |
| Example 2 | |
| Comparative | Molar ratio of Ce/Er 4.2 |
| Example 3 | |

Through the above Table 1, it can be confirmed that in the case of Examples 1 to 4, the first element such as Ce, Sm, etc. and the second element such as Er, Y, etc. were present in the dielectric layer according to an embodiment, and the molar ratio of the first element to the second element was within the range of about 1.5 to about 4.0.

### Evaluation 3: TEM-EDS Analysis

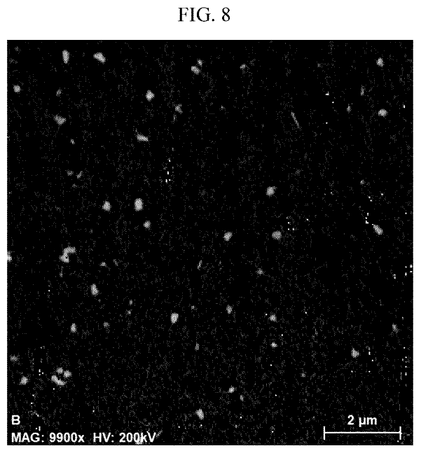

Transmission electron microscope-energy dispersive spectroscopy (TEM-EDS) analysis was performed on the multilayer ceramic capacitors manufactured in Examples 1 to 4 and Comparative Examples 1 to 3 by the following method, and the results are shown in FIGS. 8 to 11C and Table 2 below. After each multilayer ceramic capacitor was placed into an epoxy mixing solution and then cured, the L-axis and the T-axis directional surface (LT surface) of the capacitor body was polished to ½ depth in the W-axis direction to obtain a cross-sectional sample so that the active region where the dielectric layer and the internal electrode layer overlap can be observed. Specifically, when the active region was divided into three parts in the T-axis direction, i.e., the stacking direction, the upper region, the central region, and the lower region, a cross-sectional sample was obtained so that at least one dielectric layer and at least one internal electrode layer were visible in each region. The obtained cross-sectional sample was measured by TEM using a focused ion beam (FIB) under conditions of an acceleration voltage of 200 kV and a magnification of about 10 k. The measured TEM image was analyzed by EDS to confirm the presence of a Si-based secondary phase. That is, it can be confirmed that it was the Si-based secondary phase because the part where Si element was detected in the analyzed image appeared in a clumped form.

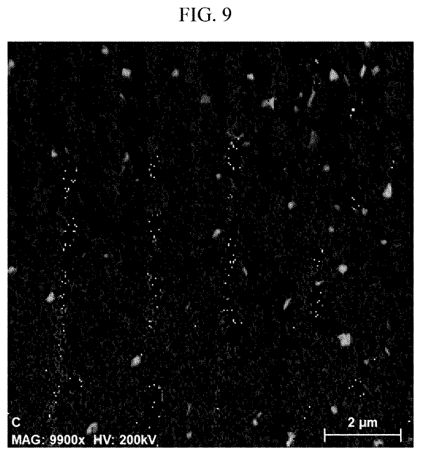

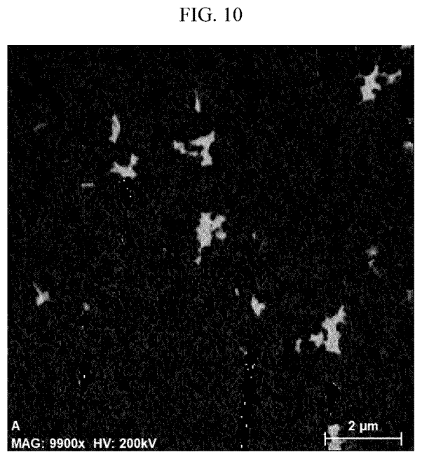

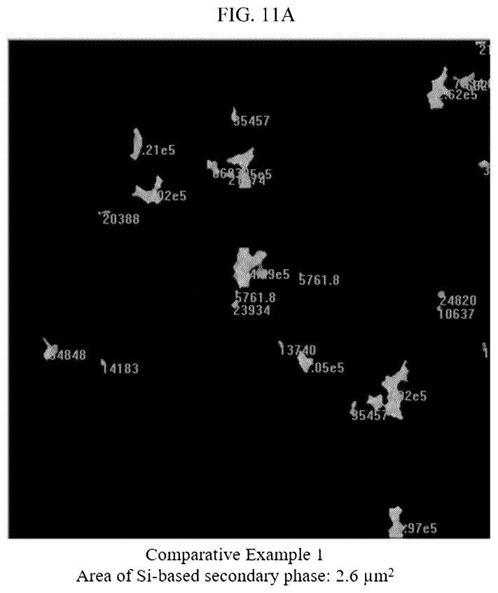

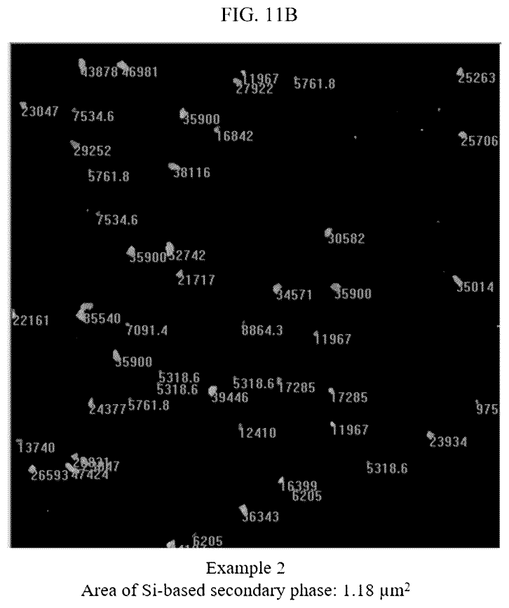

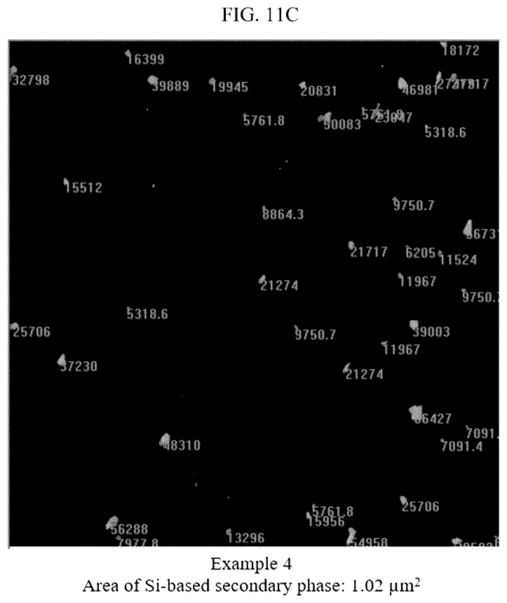

FIG. 8 is a transmission electron microscopy-energy dispersive spectroscopy (TEM-EDS) analysis image of the active region according to Example 2, FIG. 9 is a transmission electron microscopy-energy dispersive spectroscopy (TEM-EDS) analysis image of the active region according to Example 4, FIG. 10 is a transmission electron microscopy-energy dispersive spectroscopy (TEM-EDS) analysis image of the active region according to Comparative Example 1, and FIGS. 11A to 11C are each an image showing the measurement of the area of the Si-based secondary phase in the active region according to Comparative Example 1 and Examples 2 and 4, respectively.

Referring to FIGS. 8 to 10, in the case of Examples 2 and 4, it can be seen that a Si-based secondary phase existed within the dielectric layer in the active region, and compared to Comparative Example 1, it can be seen that the Si-based secondary phase existed in a smaller area even with the naked eye.

In addition, the area of the Si-based secondary phase was measured in the TEM-EDS analysis image as in FIGS. 11A to 11C, and the results are shown in Table 2 below. Specifically, the area of the Si-based secondary phase was obtained by calculating the area of the Si-based secondary phase based on an area of 10 μm×10 μm in each region in the upper region, central region, and lower region within the active region, and then calculating the average value from a total of three locations.

TABLE 2

| | | Area of Si-based |
|---|---|---|
| | Molar ratio | secondary phase |
| | between elements | (μm²) |
| Example 1 | Molar ratio of Ce/Er 1.5 | 1.13 |
| Example 2 | Molar ratio of Ce/Er 3.0 | 1.18 |
| Example 3 | Molar ratio of Ce/Er 4.0 | 1.6 |
| Example 4 | Molar ratio of Sm/Y 3.0 | 1.02 |
| Comparative | Molar ratio of Dy/Tb 3.0 | 2.6 |
| Example 1 | | |
| Comparative | Molar ratio of Ce/Er 1.3 | 2.62 |
| Example 2 | | |
| Comparative | Molar ratio of Ce/Er 4.2 | 2.3 |
| Example 3 | | |

Referring to Table 2 above, in the case of Examples 1 to 4, it can be seen that the area occupied by the Si-based secondary phase was 2.0 μm² or less based on the area of 10 μm×10 μm of the active region, whereas in Comparative Examples 1 to 3, it exceeded 2.0 μm². That is, it can be seen that the formation of the Si-based secondary phase was suppressed by more than 50% compared to Comparative Example 1 using Dy and Tb as additive components. This can be seen as a suppression of the formation of Si-based secondary phases due to the difference in the solid solution properties resulting from changes in the type of additive.

From this, it can be seen that, according to an embodiment, when the dielectric layer includes the first element such as Ce, Sm, etc. and the second element such as Er, Y, etc., and the molar ratio of the first element to the second element is within a range of about 1.5 to about 4.0, the formation of the Si-based secondary phase is suppressed, and the area of the Si-based secondary phase within the dielectric layer is reduced.

### Evaluation 4: Highly Accelerated Life Test (HALT)

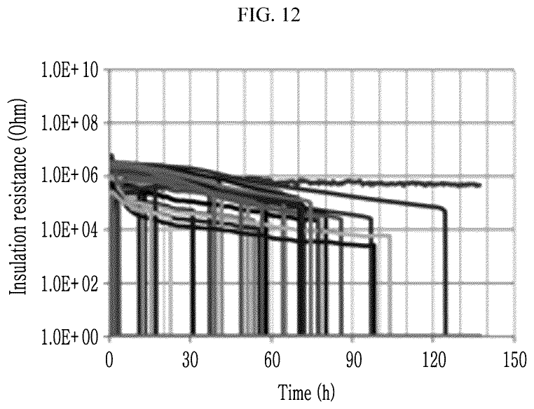

Highly accelerated life test (HALT) of the multilayer ceramic capacitors manufactured in Examples 2 and 4 and Comparative Example 1 was measured by the following method, and the results are shown in FIGS. 12 to 14.

Each multilayer ceramic capacitor was prepared in 40 units, mounted on a measurement board, and HALT was measured under the conditions of temperature 125° C., voltage 10V, and 150 hours using ESPEC (PV-222, HALT) equipment.

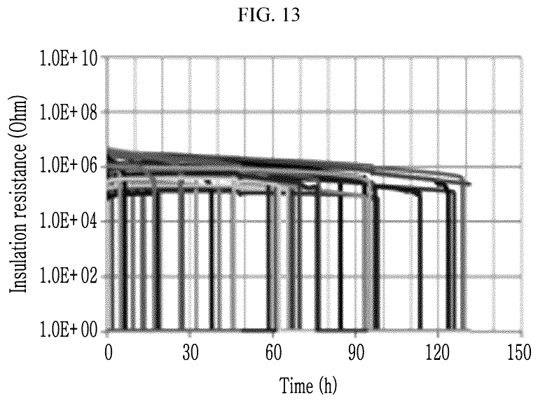

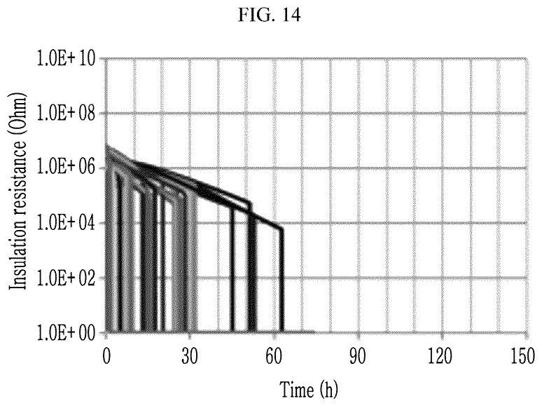

FIG. 12 is a graph evaluating highly accelerated life test (HALT) of the multilayer ceramic capacitor according to Example 2, FIG. 13 is a graph evaluating highly accelerated life test (HALT) of the multilayer ceramic capacitor according to Example 4, FIG. 14 is a graph evaluating highly accelerated life test (HALT) of the multilayer ceramic capacitor according to Comparative Example 1.

Referring to FIGS. 12 to 14, it can be seen that the highly accelerated life characteristics, i.e., reliability, of Examples 2 and 4 are superior to those of Comparative Example 1. From this, it can be seen that, according to an embodiment, when the dielectric layer includes the first element such as Ce, Sm, etc. and the second element such as Er, Y, etc., and the molar ratio of the first element to the second element is within a range of about 1.5 to about 4.0, the reliability of the multilayer ceramic capacitor is improved as the area of the Si-based secondary phase within the dielectric layer decreases.

### Evaluation 5: Mean Time to Failure (MTTF)

Mean time to failure (MTTF) of the multilayer ceramic capacitors manufactured in Examples 1 to 4 and Comparative Examples 1 to 3 was measured by the following method, and the results are shown in Table 3 below. For 40 samples of each multilayer ceramic capacitor, MTTF was measured under the conditions of temperature 125° C., voltage 10 V, and 150 hours.

TABLE 3

| | | Area of Si-based | |
|---|---|---|---|
| | Molar ratio | secondary phase | MTTF |
| | between elements | (μm²) | (hr) |
| Example 1 | Molar ratio of Ce/Er 1.5 | 1.13 | 53.85 |
| Example 2 | Molar ratio of Ce/Er 3.0 | 1.18 | 52.11 |
| Example 3 | Molar ratio of Ce/Er 4.0 | 1.06 | 57.03 |
| Example 4 | Molar ratio of Sm/Y 3.0 | 1.02 | 58.98 |
| Comparative | Molar ratio of Dy/Tb 3.0 | 2.6 | 17.21 |
| Example 1 | | | |
| Comparative | Molar ratio of Ce/Er 1.3 | 2.62 | 7.85 |
| Example 2 | | | |
| Comparative | Molar ratio of Ce/Er 4.2 | 2.3 | 9.32 |
| Example 3 | | | |

Through the above Table 3, it can be seen that Examples 1 to 4 have superior reliability compared to Comparative Examples 1 to 3.

From this, it can be seen that, according to an embodiment, when the dielectric layer includes the first element such as Ce, Sm, etc. and the second element such as Er, Y, etc., and the molar ratio of the first element to the second element is within a range of about 1.5 to about 4.0, the reliability of the multilayer ceramic capacitor is improved as the area of the Si-based secondary phase within the dielectric layer decreases.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A multilayer ceramic capacitor, comprising
a capacitor body including a dielectric layer and an internal electrode layer, and
an external electrode disposed on an outer surface of the capacitor body,
wherein the dielectric layer comprises:
a first element including at least one selected from cerium (Ce), gadolinium (Gd), samarium (Sm), and lanthanum (La); and
a second element including at least one selected from erbium (Er), yttrium (Y), thulium (Tm), and ytterbium (Yb), and
a molar ratio of the first element to the second element is 1.5 to 4.0.

2. The multilayer ceramic capacitor of claim 1, wherein
the first element comprises cerium (Ce), and
the second element comprises erbium (Er).

3. The multilayer ceramic capacitor of claim 2, wherein
a molar ratio of cerium (Ce) to erbium (Er) is 1.5 to 4.0.

4. The multilayer ceramic capacitor of claim 1, wherein
the first element comprises samarium (Sm), and
the second element comprises yttrium (Y).

5. The multilayer ceramic capacitor of claim 4, wherein
a molar ratio of samarium (Sm) to yttrium (Y) is 1.5 to 4.0.

6. The multilayer ceramic capacitor of claim 1, wherein
the dielectric layer further comprises titanium (Ti), and
the dielectric layer comprises the first element in an amount of 0.6 part by mole to 8 parts by mole based on 100 parts by mole of titanium (Ti).

7. The multilayer ceramic capacitor of claim 1, wherein
the dielectric layer further comprises titanium (Ti), and
the dielectric layer comprises the second element in an amount of 0.15 part by mole to 5 parts by mole based on 100 parts by mole of titanium (Ti).

8. The multilayer ceramic capacitor of claim 1, wherein
the dielectric layer comprises a Si-based secondary phase.

9. The multilayer ceramic capacitor of claim 8, wherein
the Si-based secondary phase comprises:
silicon (Si); and
at least one selected from cerium (Ce), gadolinium (Gd), samarium (Sm), lanthanum (La), erbium (Er), yttrium (Y), thulium (Tm), ytterbium (Yb), aluminum (Al), magnesium (Mg), and manganese (Mn).

10. The multilayer ceramic capacitor of claim 8, wherein
the Si-based secondary phase comprises silicon (Si) in an amount of 20 mol % to 80 mol % based on a total amount of the Si-based secondary phase.

11. The multilayer ceramic capacitor of claim 8, wherein
the Si-based secondary phase comprises at least one selected from:
$$\begin{matrix}{Ce}_{x} {Er}_{y} {Si}_{2} {O}_{7} , 0 \leq x \leq 2 , 0 \leq y \leq 2 , \\ {Ce}_{x} {Er}_{y} {SiO}_{5} , 0 \leq x \leq 2 , 0 \leq y \leq 2 ,\end{matrix}$$
a Si—O—Al bond-containing compound,
a Si—O—Mg bond-containing compound, and
a Si—O—Mn bond-containing compound.

12. The multilayer ceramic capacitor of claim 8, wherein
the dielectric layer includes a plurality of dielectric layers,
the internal electrode layer includes a plurality of internal electrode layers,
the capacitor body comprises an active region,
the active region comprises the plurality of dielectric layers and the plurality of internal electrode layers, where each internal electrode layer among the plurality of internal electrode layers and each dielectric layer among the plurality of dielectric layers are alternately disposed, and
an area occupied by the Si-based secondary phase is greater than 0 and less than or equal to 2.0 μm² based on an area of 10 μm×10 μm of the active region.

13. The multilayer ceramic capacitor of claim 1, wherein
the dielectric layer is free of dysprosium (Dy), terbium (Tb), or both.

14. The multilayer ceramic capacitor of claim 12, wherein
the dielectric layer comprises a Si-based secondary phase,
the dielectric layer includes a plurality of dielectric layers,
the internal electrode layer includes a plurality of internal electrode layers,
the capacitor body comprises an active region,
the active region comprises the plurality of dielectric layers and the plurality of internal electrode layers, where each internal electrode layer among the plurality of internal electrode layers and each dielectric layer among the plurality of dielectric layers are alternately disposed, and
an area occupied by the Si-based secondary phase is greater than 0 and less than or equal to 2.0 μm² based on an area of 10 μm×10 μm of the active region.

15. A multilayer ceramic capacitor, comprising
a capacitor body including:
a dielectric layer including a plurality of dielectric layers, and
an internal electrode layer including a plurality of internal electrode layers, and
an external electrode disposed on an outer surface of the capacitor body,
wherein the capacitor body comprises an active region,
the active region comprises the plurality of dielectric layers and the plurality of internal electrode layers, where each internal electrode layer among the plurality of internal electrode layers and each dielectric layer among the plurality of dielectric layers are alternately disposed,
the dielectric layer comprises:
a first element including at least one selected from cerium (Ce), gadolinium (Gd), samarium (Sm), and lanthanum (La);
a second element including at least one selected from erbium (Er), yttrium (Y), thulium (Tm), and ytterbium (Yb); and
a Si-based secondary phase, and
an area occupied by the Si-based secondary phase is greater than 0 and less than or equal to 2.0 μm² based on an area of 10 μm×10 μm of the active region.

16. The multilayer ceramic capacitor of claim 15, wherein
the Si-based secondary phase comprises:
silicon (Si); and
at least one selected from cerium (Ce), gadolinium (Gd), samarium (Sm), lanthanum (La), erbium (Er), yttrium (Y), thulium (Tm), ytterbium (Yb), aluminum (Al), magnesium (Mg), and manganese (Mn).

17. The multilayer ceramic capacitor of claim 15, wherein
the Si-based secondary phase comprises silicon (Si) in an amount of 20 mol % to 80 mol % based on a total amount of the Si-based secondary phase.

18. The multilayer ceramic capacitor of claim 15, wherein
the Si-based secondary phase comprises at least one selected from:
$$\begin{matrix}{Ce}_{x} {Er}_{y} {Si}_{2} {O}_{7} , 0 \leq x \leq 2 , 0 \leq y \leq 2 , \\ {Ce}_{x} {Er}_{y} {SiO}_{5} , 0 \leq x \leq 2 , 0 \leq y \leq 2 ,\end{matrix}$$
a Si—O—Al bond-containing compound,
a Si—O—Mg bond-containing compound, and
a Si—O—Mn bond-containing compound.

19. The multilayer ceramic capacitor of claim 15, wherein
the first element comprises cerium (Ce), and
the second element comprises erbium (Er).

20. The multilayer ceramic capacitor of claim 15, wherein
the first element comprises samarium (Sm), and
the second element comprises yttrium (Y).

21. The multilayer ceramic capacitor of claim 15, wherein
the dielectric layer further comprises titanium (Ti), and
the dielectric layer includes the first element in an amount of 0.6 part by mole to 8 parts by mole based on 100 parts by mole of titanium (Ti).

22. The multilayer ceramic capacitor of claim 15, wherein
the dielectric layer further comprises titanium (Ti), and
the dielectric layer includes the second element in an amount of 0.15 part by mole to 5 parts by mole based on 100 parts by mole of titanium (Ti).

23. A method of manufacturing a multilayer ceramic capacitor, comprising
preparing a dielectric slurry from a mixture including a barium titanate-based compound, a first element-containing compound, and a second element-containing compound;
manufacturing a plurality of dielectric green sheets from the dielectric slurry and forming a conductive paste layer on a surface of two or more dielectric green sheets among the plurality of dielectric green sheets;
manufacturing a dielectric green sheet stack by stacking the two or more dielectric green sheets on which the conductive paste layer is formed;
manufacturing a capacitor body including a dielectric layer and an internal electrode layer by firing the dielectric green sheet stack; and
forming an external electrode on a surface of the capacitor body,
wherein the first element-containing compound includes a compound containing a first element including at least one selected from cerium (Ce), gadolinium (Gd), samarium (Sm), and lanthanum (La),
the second element-containing compound includes a compound containing a second element including at least one selected from erbium (Er), yttrium (Y), thulium (Tm), and ytterbium (Yb), and
the first element-containing compound and the second element-containing compound are mixed so that a molar ratio of the first element and the second element is 1.5:1 to 4:1.

24. The method of claim 23, wherein
the first element-containing compound and the second element-containing compound are each independently an oxide, a nitride, a salt compound, or a compound in a form of a sol dispersed in an organic solvent.

25. The method of claim 24, wherein
the first element-containing compound includes cerium nitride, and
the second element-containing compound includes erbium nitride.

26. The method of claim 23, wherein
the mixture further comprises at least one selected from a silicon (Si)-containing compound, an aluminum (Al)-containing compound, a magnesium (Mg)-containing compound, and a manganese (Mn)-containing compound.

27. The method of claim 26, wherein
the silicon (Si)-containing compound, the aluminum (Al)-containing compound, the magnesium (Mg)-containing compound, and the manganese (Mn)-containing compound are each independently, when present, an oxide, a nitride, a salt compound, or a compound in a form of a sol dispersed in an organic solvent.

28. The method of claim 27, wherein
the mixture further comprises the silicon (Si)-containing compound in an amount of 0 parts by mole to about 4 parts by mole or less based on 100 parts by mole of the barium titanate-based compound.

29. The method of claim 28, wherein
the silicon (Si)-containing compound comprises silicon oxide.

30. The method of claim 29, wherein
the dielectric green sheet stack was fired under a hydrogen concentration of 1.0% H₂ or lower.
